(19) United States
(12) Patent Application Publication
(10) Pub. No.: US 2008/0301498 A1
(43) Pub. Date: Dec. 4, 2008

(54) Control device and control method

(75) Inventors: Wen-Chi Hsu, Changhua County (TW); Jia-Jou Tsai, Taipei City (TW)

Correspondence Address: KILE GOEKJIAN REED & MCMANUS, 1200 NEW HAMPSHIRE AVE, NW, SUITE 570, WASHINGTON, DC, 20036, US

(73) Assignee: HOLTEK SEMICONDUCTOR INC., Hsinchu (TW)

(21) Appl. No.: 12/031,933

(22) Filed: Feb. 15, 2008

(30) Foreign Application Priority Data
Jun. 1, 2007 (TW) 096119841

(51) Int. Cl. G06F 11/14

(52) U.S. Cl. 714/23; 714/E11.138

(57) ABSTRACT

A control device and a control method for increasing stability of micro controller system are described. The control device comprises a system error detection unit a memory unit, a data error detection unit, an error signal processing unit and a system resetting unit. When the system is error or the data transferred from the memory unit has error, the system error detection unit or the data error detection unit outputs an error signal to the error signal processing unit, and then the error signal processing unit corrects the error data or commands the system resetting unit to reset the system by the error signal for increasing the system stability.

### CROSS-REFERENCE TO RELATED APPLICATION

This application claims priority under 35 U.S.C. §119 to Taiwan Patent Application No. 096119841, filed on Jun. 1, 2007, in the Taiwan Intellectual Property Office, the entire contents of which are hereby incorporated by reference.

### BACKGROUND OF THE INVENTION

1. Field of the Invention

The present invention relates to a micro controller system, in particular, to a control device and a method thereof for increasing stability of the micro controller system.

2. Description of Related Art

In the past, micro controllers were mainly used in consumer electronics with low requirements for resistance to large temperature ranges and for resistance to electronic noise. However, in the fields of industrial control and automobile electronics, electronic noise is becoming stronger and denser and thus the components applied in these fields must possess higher electronic noise resistance, ensuring stable operations of the entire system.

When noise interferes with power lines and unstable power occurs, it is prone to have bad signals input to the devices in a system, causing wrong actions of the device and erroneous output signals, further negatively affecting operations made by other devices; or the noise interferences become so serious that the whole device may fail, causing the entire system to break down with unpredictable conditions. Common situations are: data process errors, program failure of infinite loop, system crashes.

In a conventional micro controller system, two devices are usually employed to prevent the occurrences of erroneous system actions. The first type of device is a watch dog timer (WDT) device, which is often used for detecting error conditions in a micro controller. The main detection approach of the watchdog device is to check if the micro controller works normally once every a certain period of time, and in case that an unknown error occurs, the device will immediately perform error recovery. For example, when a program runs to an unexpected process position without executing according to a designated action, then after a period of time, the WDT device detects such an error condition, it will generate an Overflow signal to notify the system for resetting, enabling the system to be reinstated in the normal operations. The second type of device is Low Voltage Detect device, which is frequently used for ensuring the voltage stability of the system. In case that a low voltage situation occurs, which may result in system instability, the Low Voltage Detect device will beforehand send a voltage error signal for performing system reset to stop system operations, so as to retain system stability.

However, the aforementioned two types of devices are still not able to handle certain more complicated erroneous conditions and errors. For example, when a program runs to an unexpected process position, therein coincidentally contains a Clear WDT instruction, thus continuously prolonging process time, or due to execution of unexpected program blocks by the erroneous actions of the system, which unfortunately shuts down the WDT device, thereby unable to use the WDT device to detect erroneous conditions and to restore the system by means of the Overflow function. Furthermore, although the voltage, for example, did drop too low, but this condition was transient and existed so short that the Low Voltage Detect device missed such an erroneous phenomenon, which, however, may have already caused unfavorable influences to the system stability; as a result, it is very likely that the system may fail and cannot be recovered.

In a traditional system, if noise or voltage has reached a status that errors may occur, but the system breaks down or even is unable to be restored back to normal operations because that such an erroneous condition was not detected, then the component is very improper and unpractical to be applied in an environment of high noise. Therefore, for the micro controller to be used in an environment of high noise, it should present not only robust anti-noise ability, but also possess powerful system self-restoration function, so as to increase the stability of the system.

### SUMMARY OF THE INVENTION

In view of the aforementioned issues, the present invention provides a method for increasing stability of a micro controller (MCU) system, which, through the error detecting device provided by the system, detects first various error conditions, then according to the error conditions detected, sends signals to notify the error processing device for proper handling, thereby reducing the chance of occurrences of system erroneous actions due to error conditions, further increasing the stability of the system.

To achieve the above-mentioned objectives, the present invention provides a control device, including a system error detection unit, which is used for detecting whether a micro controller system operates normally, and when the micro controller system operates abnormally, it outputs a system error signal; a system resetting unit, which is used for resetting the micro controller system; and an error signal processing unit, which is used for receiving the system error signal so as to output a system reset signal; wherein, if the error signal processing unit receives the system error signal, then the error signal processing unit will output the system reset signal to the system resetting unit for resetting the micro controller system.

To achieve the above-mentioned objectives, the present invention further provides a control device, including a memory unit, used for data storage; a data error detection unit, which is used to perform error detection on data from the memory unit, and upon the detection of error in the data transferred from the memory unit, it outputs a data error signal; a system resetting unit, which is used for resetting a micro controller system; and an error signal processing unit, which is used to receive the data error signal, so as to output a system resetting signal or to correct the error data from the memory unit; wherein if the error signal processing unit receives the data error signal, then the error signal processing unit will correct the error data from the memory unit, or output the system reset signal to the system resetting unit for resetting the micro controller system.

To achieve the above-mentioned objectives, the present invention further provides a control method of increasing the stability of a micro controller system, including the following steps: to provide a system error detection unit to determine whether there is an error in the micro controller system; to provide an error signal processing unit, in which, based on the determination of the system error detection unit, if an error occurs in the micro controller system, it issues a system reset request; and to provide a system resetting unit for performing the system reset request issued by the error signal processing unit.

To achieve the above-mentioned objectives, the present invention further provides a control method of increasing the stability of a micro controller system, including the following steps: to provide a data error detection unit for detecting whether there is an error in the data transferred from the memory unit of the micro controller system; to provide an error signal processing unit, which, based on the determination of the data error detection unit, if an error occurs in the data transferred from the memory unit, it issues a system reset request or corrects the data transferred from the memory unit of the micro controller system; and to provide a system resetting unit for performing the system reset request issued by the error signal processing unit.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a functional block diagram of the control device according to the present invention;

FIG. 2 is a functional block diagram of the system error detection unit;

FIG. 3 is a flowchart of the method for system error detection according to the present invention;

FIG. 4 is a functional block diagram of the data error detection according to the present invention; and

FIG. 5 is a flowchart of the control method for increasing micro controller system stability according to the present invention.

### DETAILED DESCRIPTION OF THE PREFERRED EMBODIMENTS

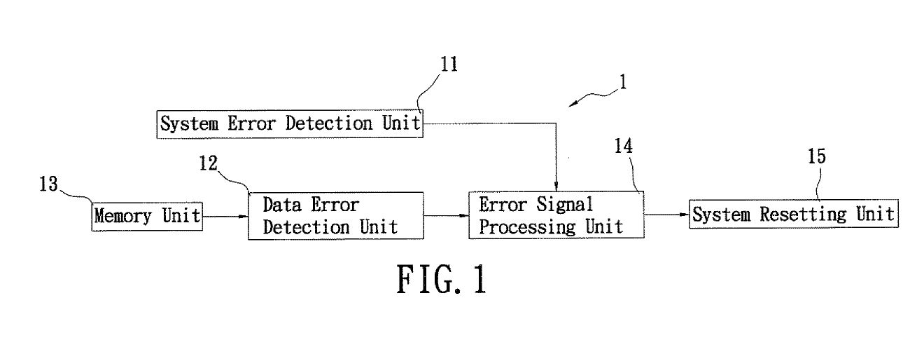

Referring now to FIG. 1, in which a functional block diagram of the control device according to the present invention is shown. The control device of the present invention includes a system error detection unit 11, a memory unit 13, a data error detection unit 12, an error signal processing unit 14 and a system resetting unit 15.

The control device 1 employs the system error detection unit 11 to determine if a micro controller system (not shown) is in a stable condition. When the system error detection unit 11 detects any system instability, it sends a signal to notify the error signal processing unit 14, instructing the system resetting unit 15 to perform system reset, thus preventing any possible occurrences of system error or breakdown in case that the system continues to operate under unstable system condition.

When the system power becomes unstable or noise interference deteriorates, the data acquired from the memory unit 13 by the micro controller system (not shown) probably contains errors, and in case that the data errs, program codes or the data to be processed possibly become unpredictable. Hence, suppose the system happens to execute the erroneous program codes, it will result in system breakdown or even unrecoverable crash.

Regarding to the above-mentioned issues, the present invention adds information of error check and error correction functions for the data stored in the memory unit 13, so as to, upon reading, first perform determination on data correctness, and in case that any data error should be found, it is possible to recover originally correct data by means of this additional information. Therefore, each data acquired from the memory unit 13 will be subject to a confirmation action executed by the data error detection unit 12 for determining if an error exists therein, and in case the existence of any data error is detected, the data will be sent to the error signal processing unit 14 for data correction. Suppose there are too many data errors to handle, the system will be notified to execute re-send instruction in terms of this piece of data, requesting the memory unit 13 to send the data again.

Besides, when the data error detection unit 12 performs confirming operation on the data acquired from the memory unit 13, if it finds that the address range to which the data corresponds exceeds the border, then it will notify the error signal processing unit 14 about the occurrence of error, and the error signal processing unit 14 will instruct the system resetting unit 15 to perform an action of system reset. By means of the error detection on transferred data, and further through the data error correction or system reset, it is possible to avoid sending wrong data into the system for execution, which may result in occurrences of unpredictable conditions.

Next, the operation principles and relations of each unit in the control device 1 according to the present invention will be described.

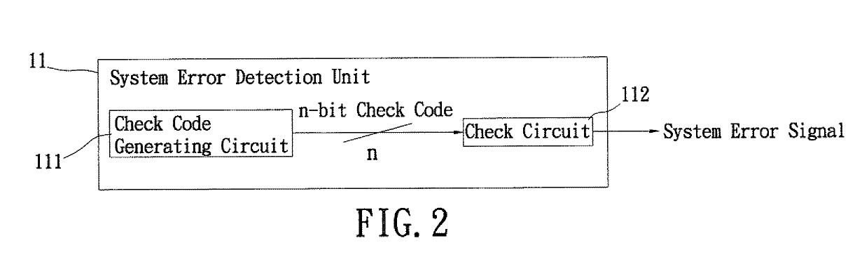

Referring to FIG. 2, in which a functional block diagram of the system error detection unit is shown. The control device 1 determines whether the system functions normally by means of a check code. As shown in FIG. 2, the system error detection unit 11 includes a check code generating circuit 111 and a check circuit 112; in which the check code generating circuit 111, based on the system operation condition, constantly outputs a check code of n bits (n means plurality), while the check circuit 112 checks the check code generated by the check code generating circuit 111 with a predetermined check code once every a period of time, so as to confirm whether the system works normally. For example, the check code generating circuit 111 constantly outputs a check code, e.g. of 4 bits. If the check code is 1100₍₂₎ and the predetermined check code is 1100₍₂₎ as well, the check circuit 112 compares and finds that the check code indeed matches the predetermined check code, then this means the system works normally; however, if the check code is 1110₍₂₎ but the predetermined check code is 1100₍₂₎, then the check circuit 112 compares and finds that the check code does not match the predetermined check code, then the system is shown to be working erroneously.

Since, when the system is unstable, the behavior of the check code generating circuit 111 will be accordingly unstable; thus once the existence of check code error is detected, it can determine that the system needs to stop working. Therefore, when the check code is found to be erroneous, the system error detection unit 11 will output a system error signal for notifying the error signal processing unit 14 to perform the system reset request, enabling the system resetting unit 15 to reset the system; after the system reset this check code will be checked again to determine whether the system has been restored to normal condition; if not normal yet, the error signal processing unit 14 will be constantly notified to request the system resetting unit 15 to perform system reset, until the system is back to be normal.

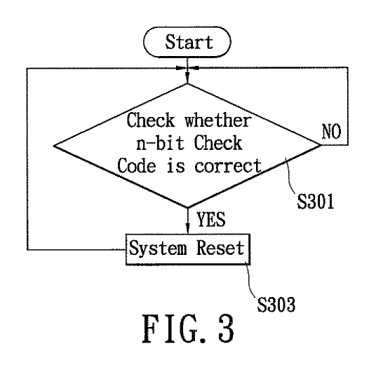

Referring again to FIG. 3, in which a flowchart of the method for system error detection according to the present invention is shown. After that the check code generating circuit 111 has output an n-bit check code, the check circuit 112 periodically checks whether the n-bit check code is correct (as step S301); if the check code is correct, this means the system work normally, the checking will be constantly performed; however, if the check code indicates errors exist, then the system operates abnormally, the error signal processing unit 14 will be notified to perform system reset request (as step S303), and after the system reset, this check code will be checked again to determine whether the system has been restored to normal condition;

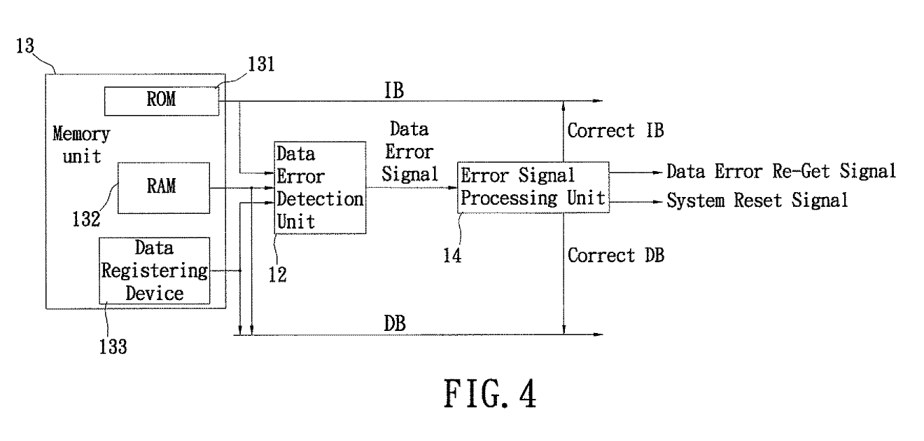

Referring now to FIG. 4, in which a functional block diagram of the data error detection according to the present invention is shown. The memory unit 13 in the control device 1 according to the present invention includes at least a volatile memory or non-volatile memory; as shown in the diagram, the memory unit 13 includes a Read-Only Memory (ROM) 131, a Random Access Memory (RAM) 132 and a data registering device 133, in which such a data registering device 133 can be ROM, RAM or registers etc. The ROM 131 in mainly used for storing programs, outputting instructions to the instruction bus (IB); the RAM 132 is essentially used to store data required for operations of micro controller (not shown); the data registering device 133 is used for the storage of certain system data. The RAM 132 and the data registering device 133 will send the data that the system intends to use to the data bus (DB) for system reading.

The data output by the memory unit 13, including the data in the ROM 131, the RAM 132 as well as the data registering device 133, will be subject to the data error check performed by the data error detection unit 12. If the data error detection unit 12 finds that the address range to which the data transferred from the memory unit 13 corresponds exceeds a predetermined range (e.g. the accessible data range is set to be in 00H˜6FH but a value of 70H is found, which means an action of crossing beyond the border), it can determine the occurrence of error, the data error detection unit 12 will then send a data error signal to the error signal processing unit 14, and the error signal processing unit 14 will send a system reset signal to the system resetting unit 15, requesting the system resetting unit 15 to perform system reset action so as to fix this error.

Besides, in terms of each data from the memory unit 13, the data error detection unit 12 uses error correction codes to check whether the input data is correct, and once the occurrence of data error is found, the data error detection unit 12 will send a data error signal to notify the error signal processing unit 14, requesting the error signal processing unit 14 to perform data restoration action.

Thus, when the error signal processing unit 14 has learned, based on the data error signal, that errors have been found in the data transferred from the memory unit 13 after the error correction code check, it will first use the error correction code to attempt to fix the error data, if this renders successful correction, then the system can continue to operate without being interrupted by the error. If, however, such a correction does not work, then a data error re-get signal will inevitably be sent to the system, so as to request the memory unit 13 to send again the data. In case the error signal processing unit 14 has learned, based on the data error signal, that the reason for the data error is the accessed data range is beyond the system predetermined range, it will accordingly determine the existence of system errors and immediately notify the system resetting unit 15 to reset the system.

When the error signal processing unit 14 receives the data error signal, the error signal processing unit 14 will first perform the data correction. However, for the structure of a general micro controller, suppose a program is found to have errors, the corrected result will be directly put in the instruction bus to replace the wrong program, and the corrected operation data will be placed on the data bus, thus accomplishing the data correction.

As described supra, it can be seen that, in the control device 1 according to the present invention, when the system instability is detected, the system resetting unit 15 will be notified to immediately reset the system to ensure the system stability. While the function of the above-mentioned system resetting unit 15 is to reset the system, in the situation of system reset, the system will not perform any program and internal operations, which is similar to a stop status.

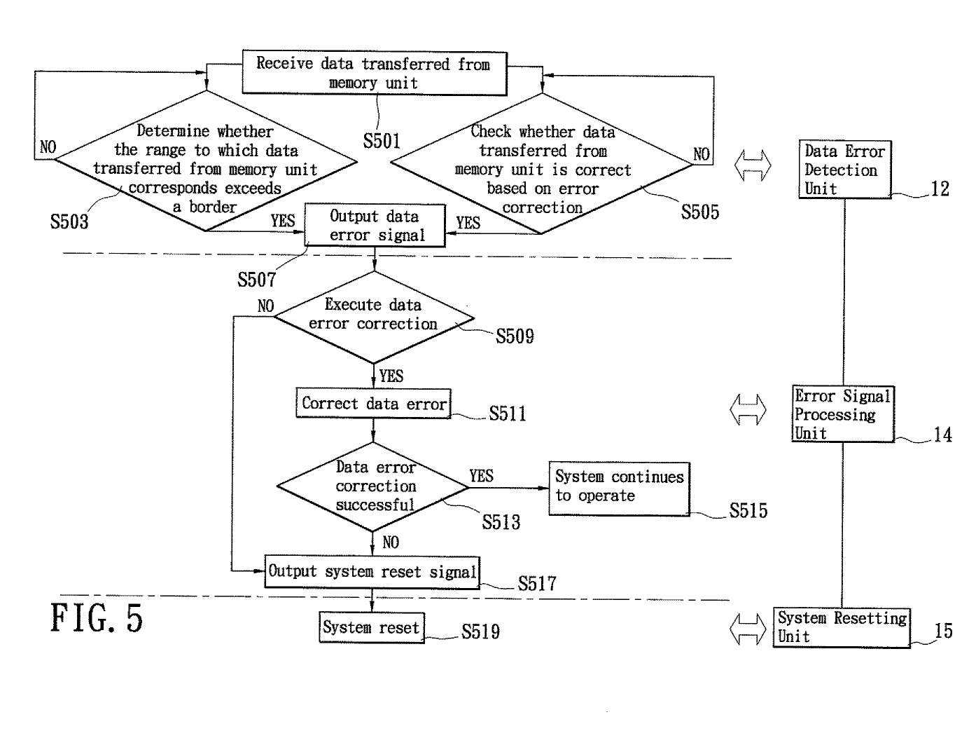

Finally, referring to FIG. 5, a flowchart of the control method for increasing micro controller system stability according to the present invention is shown. First, the data error detection unit 12 receives the data transferred from the memory unit 13 (as step S501), then it respectively determines whether the address range to which the data transferred from the memory unit 13 corresponds exceeds the border (as step S503), and checks whether the data transferred from the memory unit 13 is correct based on the error correction codes (as step S505); if the address range to which the data transferred from the memory unit 13 corresponds does exceed the border, or, based on the error correction codes, the data transferred from the memory unit 13 is erroneous, then the data error detection unit 12 outputs a data error signal to the error signal processing unit 14 (as step S507).

After that the error signal processing unit 14 has received the data error signal, it will, based on whether such a data error signal is generated in step S503 or in step S505, determine whether the data error correction should be performed (as step S509). Suppose the data error signal is generated in step S503, then the error signal processing unit 14 needs not to perform the error data correction, but outputs a system reset signal to the system resetting unit 15 (as step S517); if, whereas, the data error signal is generated in step S505, then the error signal processing unit 14 performs the error data correction (as step S511), and determines based on whether the data correction is successful (as step S513); if the data correction is successful, then the system continues to operate normally (as step S515); but in case that the data correction fails, the error signal processing unit 14 will output a system reset signal to the system resetting unit 15 (as step S517).

At last, upon the reception of the system reset signal at the system resetting unit 15, the system reset action will be performed for ensuring the stability of system operation (as step S519).

In summary, through the error detecting device provided by the system, it detects first various error conditions, then, according to the error conditions detected, sends signals to notify the error processing device for proper processes, thereby reducing the chance of occurrences of system erroneous actions due to error conditions, further increasing the stability of the system.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A control device, which includes:
a system error detection unit, which is used for detecting whether a micro controller system operates normally and for outputting a system error signal when the micro controller system operates abnormally;
a system resetting unit, which is used for resetting the micro controller system; and
an error signal processing unit, which is used for receiving the system error signal so as to output a system reset signal;
wherein, if the error signal processing unit receives the system error signal, then the error signal processing unit will output the system reset signal to the system resetting unit for resetting the micro controller system.

2. The control device according to claim 1, wherein the system error detection unit includes a check code generating circuit used to generate a check code consisting of a plurality of bits, the system error detection unit checks whether the check code is correct so as to confirm whether the micro controller system operates normally.

3. The control device according to claim 2, wherein the system error detection unit further includes a check circuit used to compare the check code with a predetermined check value, and the system error detection unit outputs the system error signal when the comparison result is negative (check code and check value do no match).

4. The control device according to claim 1, farther includes:
a memory unit, used for data storage;
a data error detection unit, which is used to perform error detection on data from the memory unit, and upon the detection of an error in the data transferred from the memory unit, outputs a data error signal;
wherein if the error signal processing unit receives the data error signal, then the error signal processing unit will correct the error data from the memory unit, or output the system reset signal to the system resetting unit for resetting the micro controller system.

5. The control device according to claim 4, wherein the data error signal is generated in a way that the data error detection unit detects that the address to which the data transferred from the memory unit corresponds exceeds a border, whereby after the error signal processing unit has received the data error signal, it outputs the system reset signal to the system resetting unit to reset the micro controller system.

6. The control device according to claim 4, wherein the data error detection unit uses an error correction code to check whether the data transferred from the memory unit is correct, and when an error is detect in the data, outputs the data error signal, so as to enable the error signal processing unit to correct the erroneous data from the memory unit.

7. The control device according to claim 4, wherein the error signal processing unit uses an error correction code to correct the erroneous data from the memory unit.

8. The control device according to claim 4, wherein the memory unit includes at least a non-volatile memory and a volatile memory.

9. The control device according to claim 4, wherein the memory unit includes at least one of a read-only memory, a random access memory and a register.

10. A control device, which includes:
a memory unit, used for data storage;
a data error detection unit, which is used to perform error detection on data from the memory unit, and upon the detection of error in the data transferred from the memory unit, it outputs a data error signal;
a system resetting unit, which is used for resetting a micro controller system; and
an error signal processing unit, which is used to receive the data error signal, so as to output a system resetting signal or to correct the error data from the memory unit;
wherein, if the error signal processing unit receives the data error signal, then the error signal processing unit will correct the error data from the memory unit, or output the system reset signal to the system resetting unit for resetting the micro controller system.

11. The control device according to claim 10, wherein the data error signal is generated in a way that the data error detection unit detects that the address to which the data transferred from the memory unit corresponds exceeds a border, thereby after that the error signal processing unit has received the data error signal, it outputs the system reset signal to the system resetting unit to reset the micro controller system.

12. The control device according to claim 10, wherein the data error detection unit uses an error correction code to check whether the data transferred from the memory unit is correct, and if an error is detected in the data, it outputs the data error signal, so as to enable the error signal processing unit to correct the erroneous data from the memory unit.

13. The control device according to claim 10 wherein the error signal processing unit uses an error correction code to correct the erroneous data transferred from the memory unit.

14. The control device according to claim 10 wherein the memory unit includes at least a non-volatile memory and a volatile memory.

15. The control device according to claim 10, wherein the memory unit includes at least one of a read-only memory, a random access memory and a register.

16. A control method of increasing the stability of a micro controller system, which includes the following steps:
providing a data error detection unit for detecting whether there is an error in the data transferred from the memory unit of the micro controller system;
providing an error signal processing unit, which, if an error is detected by the data error detection unit in the data transferred from the memory unit, issues a system reset request or corrects the data transferred from the memory unit of the micro controller system; and
providing a system resetting unit for performing the system reset request issued by the error signal processing unit.

17. The control method according to claim 16, wherein the system error detection unit determines whether the micro controller system operates normally by means of generating a check code of a plurality of bits, and periodically checking the check code to confirm whether the micro controller system operates normally.

18. The control method according to claim 17, wherein the system error detection unit compares the check code with a predetermined check value, and if the comparison result is negative (codes do not match), then indicates that an error has occurred in the micro controller system.

19. The control method according to claim 16, further including the following steps:
providing a data error detection unit for detecting whether there is an error in the data transferred from the memory unit of the micro controller system; and
if the data error detection unit detects an error in the data transferred from the memory unit, the data error detection unit notifies the error signal processing unit to perform data error correction or issues a system reset request.

20. The control method according to claim 19, wherein, if the data error detection unit detects that the address range to which the data transferred from the memory unit corresponds exceeds a border, the data error detection unit notifies the error signal processing unit to issue a system reset request.

21. The control method according to claim 19, wherein the data error detection unit uses an error correction code to check whether the data transferred from the memory unit is correct, and if an error is detected in the data, the data error detection unit notifies the error signal processing unit to perform data error correction.

22. The control method according to claim 19, wherein the error signal processing unit uses an error correction code to perform data error correction.

23. The control method according to claim 19, wherein, while the error signal processing unit performs data error correction, it requests the memory unit of the micro controller system to re-send the data if the error signal processing unit cannot correct the erroneous data.

24. A control method of increasing the stability of a micro controller system, which includes the following steps:
providing a data error detection unit for detecting whether there is an error in the data transferred from the memory unit of the micro controller system;
providing an error signal processing unit, which, if an error has been detected by the data error detection unit in the data transferred from the memory unit, the data error detection unit issues a system reset request or corrects the data transferred from the memory unit of the micro controller system; and
providing a system resetting unit for performing the system reset request issued by the error signal processing unit.

25. The control method according to claim 24, wherein if the data error detection unit detects that the address range to which the data transferred from the memory unit corresponds exceeds a border, the data error detection unit notifies the error signal processing unit to issue a system reset request.

26. The control method according to claim 24, wherein the data error detection unit uses an error correction code to check whether the data transferred from the memory unit is correct, and if an error is detected in the data, the data error detection unit notifies the error signal processing unit to perform data error correction.

27. The control method according to claim 24, wherein the error signal processing unit uses an error correction code to correct the data transferred from the memory unit of the micro controller system.

28. The control method according to claim 24, wherein, while the error signal processing unit corrects the data transferred from the memory unit of the micro controller system, it requests the memory unit of the micro controller system to re-send the data if the error signal processing unit cannot correct the erroneous data.
